(19) United States
(12) Patent Application Publication
(10) Pub. No.: US 2006/0248163 A1
(43) Pub. Date: Nov. 2, 2006

(54) Systems, methods, and apparatus for video frame repeat indication & processing

(76) Inventor: Alexander MacInnis, Lake Oswego, OR (US)

Correspondence Address: MCANDREWS HELD & MALLOY, LTD, 500 WEST MADISON STREET, SUITE 3400, CHICAGO, IL, 60661, US

(21) Appl. No.: 11/412,313

(22) Filed: Apr. 26, 2006

Related U.S. Application Data
(60) Provisional application No. 60/675,781, filed on Apr. 28, 2005.

(51) Int. Cl. H04N 5/00; G06F 15/16

(52) U.S. Cl. 709/217; 386/125

(57) ABSTRACT

Presented herein are system(s), method(s), and apparatus for video frame repeat indication and processing. In one embodiment, there is presented a method for transmitting video data. The method comprises transmitting a picture and an indicator with the picture, where the indicator indicates whether the picture is repeated.

### RELATED APPLICATIONS

This application claims priority to “Systems, Methods, and Apparatus for Video Frame Repeat Indication & Processing”, Provisional Application for U.S. Patent, Ser. No. 60/675,781 (Attorney Docket No. 16641US01), filed Apr. 28, 2005 by MacInnis, which is incorporated herein by reference for all purposes.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

A video signal includes pictures forming video data. The pictures can be captured and displayed at different rates, in accordance with the camera and display device. Accordingly, a media player can provide the pictures at a different rate than the rate at which the video is encoded. For example, the video may be encoded at 24 frames per second progressive, called 24p, and the media player may output 60 frames per second progressive, called 60p, or other formats such as 60 fields per second interlaced called 60i, or 30 frames per second progressive called 30p. The media player may also output pictures at a different rate than the rate that the display device displays them. For example, the video may be output from the media player at 60 fields per second interlaced (60i) and the display device may display the video pictures at 60 frames per second progressive (60p) or for example 72 frame per second progressive (72p).

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the present invention may be found in a system, method, and/or apparatus for video frame repeat indication & processing, substantially as shown in and/or described in connection with at least one of the figures, as set forth more completely in the claims.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1A is a block diagram of an exemplary system for displaying video data in accordance with an embodiment of the present invention;

FIG. 1B is a block diagram of another exemplary system for displaying video data in accordance with an embodiment of the present invention;

FIG. 2A is a block diagram of an exemplary data structure in accordance with an embodiment of the present invention;

FIG. 2B is a block diagram of another exemplary data structure in accordance with an embodiment of the present invention;

FIG. 2C is a timing diagram in accordance with an embodiment of the present invention;

FIG. 3 is a block diagram of an exemplary decoder in accordance with an embodiment of the present invention;

FIG. 4 is a block diagram of an exemplary display device in accordance with an embodiment of the present invention;

FIG. 5 is a flow diagram for displaying video data in accordance with another embodiment of the present invention; and

FIG. 6 is a block diagram describing conversion from 24p to 60i in accordance with an embodiment of the present invention;

FIG. 7 is a block diagram describing conversion from 30p to 60p in accordance with an embodiment of the present invention;

FIG. 8 is a block diagram describing conversion from 24p to 72p in accordance with an embodiment of the present invention;

FIG. 9 if a block diagram describing conversion from 30p to 72p in accordance with an embodiment of the present invention; and

FIG. 10 is a block diagram describing conversion from 30p to 75p in accordance with an embodiment of the present invention.

### DETAILED DESCRIPTION OF THE INVENTION

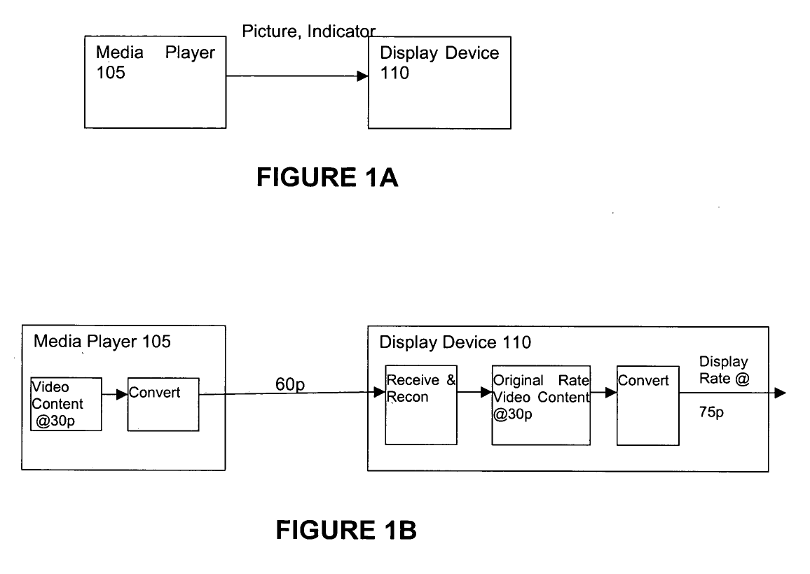

Referring now to FIG. 1A, there is illustrated a block diagram describing an exemplary system in accordance with an embodiment of the present invention. The system comprises a media player 105 and a display device 110. The media player 105 provides a video signal for display on the display device 110. The media player 105 can comprise a variety of devices, such as a DVD player, cable set top box, or satellite receiver. In cases with compressed video data, the media player 105 decompresses the compressed video data.

The video signal includes the pictures forming the video data. The media player 105 can provide the pictures at a different rate than the rate at which the video is encoded. For example, the video may be encoded at 24 frames per second progressive, called 24p, and the media player 105 may output 60 frames per second progressive, called 60p, or other formats such as 60 fields per second interlaced called 60i, or 30 frames per second progressive called 30p. The media player 105 may also output pictures at a different rate than the rate that the display device 100 displays them. For example, the video may be output from the media player 105 at 60 fields per second interlaced (60i) and the display device may display the video pictures at 60 frames per second progressive (60p) or for example 72 frames per second progressive (72p).

In one embodiment of the invention the media player 105 transmits a “repeat” bit associated with the frames of video that it outputs. The repeat bit indicates that the current output frame is a repeat of the previous frame. Alternatively, the media player 105 transmits a two-bit repeat field associated with the frame video it outputs, and the repeat field indicates how many times (0 through 3) the current frame will be repeated in the immediate future. In another embodiment the media player 105 transmit a repeat bit associated with the fields of video it outputs, and the repeat bit indicates that the current field is a repeat of the previous field of the same polarity, i.e. a repeat of the field that was output two fields ago. In another embodiment the player outputs a repeat field associated with every field that it outputs, indicating how many times in the current field will be repeated, the repeats occurring in the immediate future on fields of the same polarity.

The indicator can be transmitted with the picture in a number of ways. In one embodiment, the bit can be appended or prepended to the picture. Alternatively, the picture can include a header, and the indicator can be a field in the header. In another embodiment, the indicator can be transmitted during a vertical blanking interval associated with the picture.

Referring now to FIG. 1B, there is illustrated a block diagram of another exemplary system for displaying video data in accordance with an embodiment of the present invention. The system comprises a media player 105 and a display device 110.

The media player 105 can receive video content at a first rate, e.g., 30p and can convert the video content to another rate, e.g., 60p. In the exemplary case of converting 30p to 60p, the media player 105 repeats every frame one time. Additionally, according to certain embodiments of the present invention, the media player 105 can mark each repeated frame, and each repetition frame with appropriate indicator bits indicating the same.

The display device 110 receives the video content at the second display rate, e.g., 60p. The display device 110 uses the indicator bits to reconstruct the content at the original rate, e.g., 30p. The display device 110 can then convert the video content to another rate, such as the display rate, e.g., 75p.

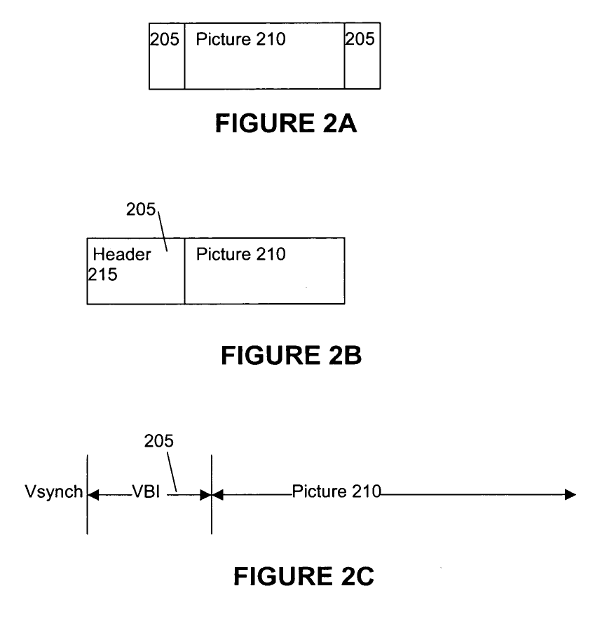

Referring now to FIG. 2A, there is illustrated a block diagram of an exemplary data structure in accordance with an embodiment of the present invention. The data structure comprises an exemplary picture 210. The picture 210 can comprise a decoded picture 210 with pixels. A repeat indicator bit(s) 205 can be appended or prepended to the picture 210.

Referring now to FIG. 2B, there is illustrated a block diagram of another exemplary data structure in accordance with an embodiment of the present invention. The data structure comprises a header 215 and a picture 210. The header 215 comprises various information about the picture 210. The header 215 also comprises repeat indicator bit(s) 210. The repeat indicator bit(s) 205 can form a field within the header 215.

Referring now to FIG. 2C, there is illustrated a diagram in accordance with an embodiment of the present invention. A vertical blanking interval 220 occurs between a vertical synchronization pulse, vsynch, and the display of the picture 210. The repeat indicator bit(s) 205 can be transmitted during the vertical blanking interval 220.

Although the foregoing illustrations are depicted with pictures, it should be understood that in certain embodiments, either frame pictures or field pictures can be used.

According to certain aspects of the present invention, the media player device 105 can comprise a decoding device for decoding video and audio data that is compressed in accordance with any one or more of a variety of compression standards, such as, but not limited to MPEG-2, Advanced Video Coding, and VC-1.

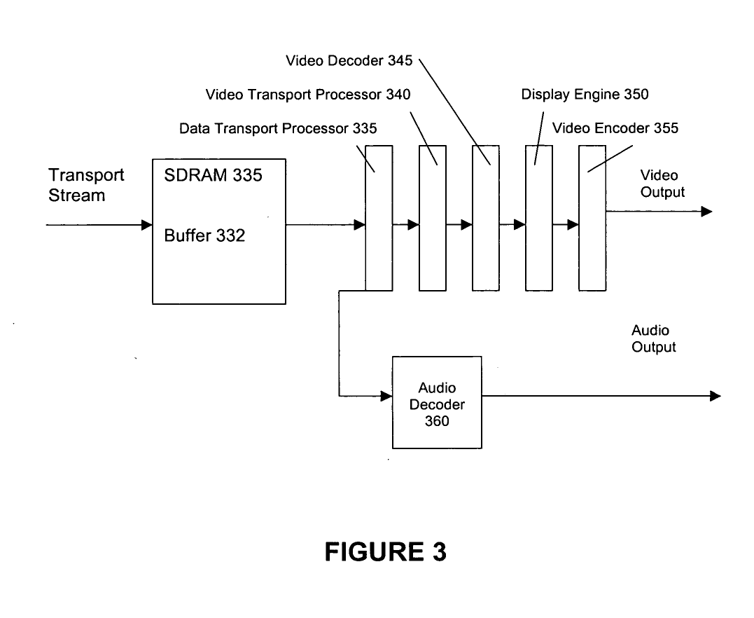

Referring now to FIG. 3, there is illustrated a block diagram of an exemplary decoder in accordance with an embodiment of the present invention. Data is output from buffer 332 within SDRAM 330. The data output from the compressed data buffer 332 is then passed to a data transport processor 335. The data transport processor 335 demultiplexes the transport stream into an audio elementary stream and transport packets comprising video elementary stream data, and passes the audio elementary stream to an audio decoder 360 and the video transport packets to a video transport decoder 340 and then to a video decoder 345. The audio data is then sent to the output blocks, and the video is sent to a display engine 350.

The display engine 350 scales the video picture, renders the graphics, and constructs the complete display images. Once a display image is ready to be presented, it is passed to a video encoder 355 where it is converted to analog video using an internal digital to analog converter (DAC). The digital audio is converted to analog in an audio digital to analog converter (DAC) 365. In an alternative embodiment, the video encoder 355 converts the display images to digital signals, which may be transmitted to a display device.

According to certain aspects of the present invention, the video encoder 355 can write the repeat indicator bit(s) as illustrated in FIGS. 2A-2C.

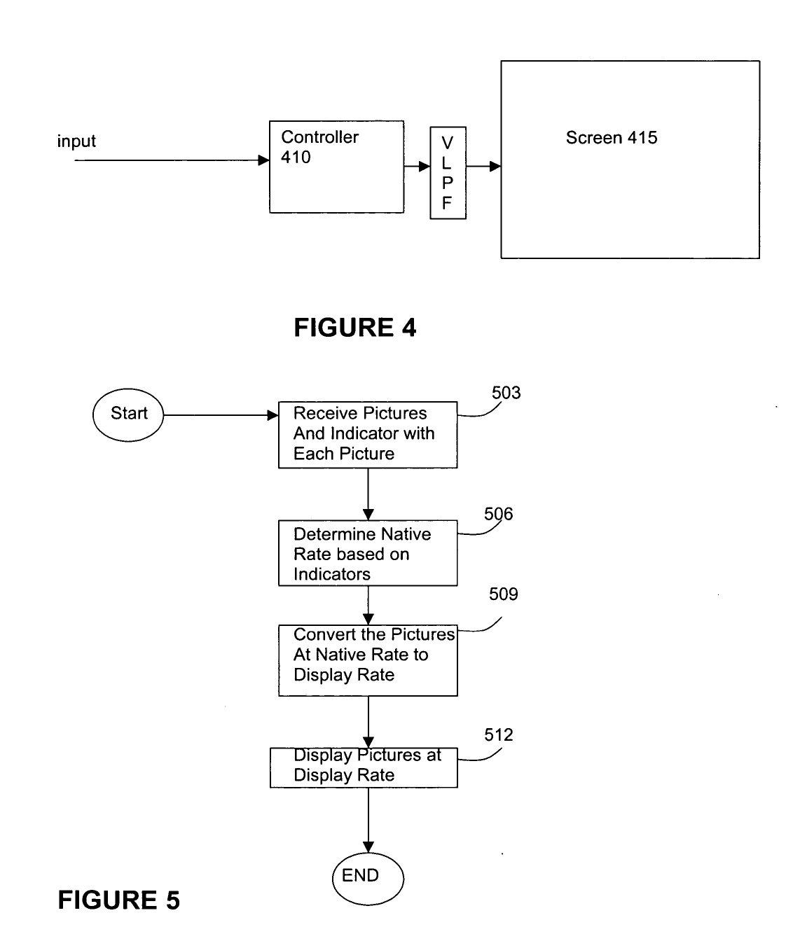

Referring now to FIG. 4, there is illustrated a block diagram of an exemplary display device 110. The display device 110 comprises an input 405, a controller 410, and a screen 415. The input 405 receives the video pictures and the indicators. The controller 410 examines the indicator.

If the display is converting the frame rate and/or converting between interlaced and progressive (either direction) it may utilize the repeat bits to reconstruct the frames of content from the player at the content's own or native rate, and the display may convert this reconstructed set of frames to a different frame rate and/or interlaced or progressive format. In many cases the display effectively eliminates the repeated frames or fields when reconstructing the content's native frame rate.

The display system may utilize the repeat information to infer or reconstruct the format of the video before it was converted from the encoded format to the display format. For example, a display receiving 60p format of video that was encoded as 24p may reconstruct the 24p format at least in part by ignoring or deleting the redundant frames or fields as indicated by the repeat information. The display system may convert the resulting reconstructed video (in the encoded format) into a different format that is suitable for further use by the display system. In one embodiment, the display system has an internal display function for the screen 215 at 72p (the display rate), and converts the 24p to 72p by repeating each of the 24p frames twice (i.e. display each one three times). Alternatively the display may create additional repeats from its input format (i.e. the output format of the player) to result in 72p, with each 24p original frame being displayed 3 times.

In another embodiment the display system processes each original 24p frame to produce an interlaced display format at a suitable field display rate. This processing may include vertical low pass filtering VLPF, also referred to as Kell filtering, of the progressive frames, to reduce or eliminate interlace flicker, and then repeats fields as appropriate to produce an interlaced format that is suitable for the display. For example, the display may convert the input video to 60i. In another example the display may convert the input format to 100i. In another embodiment the format output by the media player 105 and input to the display system is 60i, which may have been converted by the player from 24p. The display system may utilize the field repeat information to infer the 24p format. The player may convert from the inferred 24p format to a format and display rate suitable to the display, such as 60p, 72p, or 100i.

In certain embodiments, the controller 410 can perform each of the foregoing conversions to the display rate. The screen 415 can then display the pictures at the display rate.

Referring now to FIG. 5, there is illustrated a flow diagram for displaying pictures in accordance with an embodiment of the present invention. At 503, the display device 110 receives pictures, and indicators with each picture that indicate whether the picture is repeated.

At 506, the display device 110 determines the native rate that the pictures were captured at based on the indicators. At 509, the display device converts the pictures to the display rate. It is noted that the converison to the display rate can involve changing interlaced pictures to progressive and vice versa. At 512, the display device 110 displays the pictures at the display rate.

The table below describes an exemplary scheme for marking pictures. The indicator can comprise 5 bits indicating the conditions described below.

First Bit 0 Picture is a repetition
1 Picture will be repeated

2^{nd}, 3^{rd} Bits 00 No Repeat
01 1^{st} Repetition/Repeat Once
10 2^{nd} Repetition/Repeat Twice
11 3^{rd} Repetition/Repeat Thrice

4^{th}, 5^{th} Bit 0X Pertains to Entire Frame
10 Pertains to Top Field
11 Pertains to Bottom Field

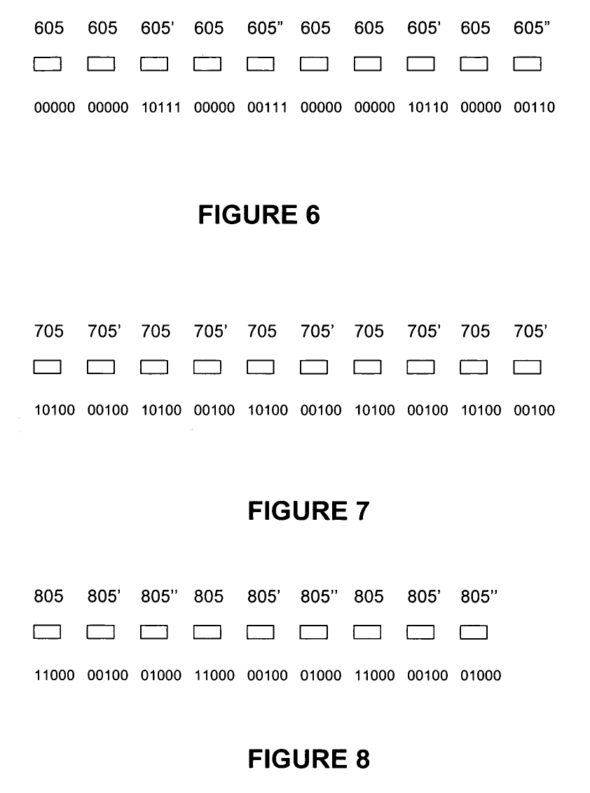

Referring now to FIG. 6, there is illustrated a block diagram describing conversion from 24p to 60i in accordance with an embodiment of the present invention. The original rate of the video is 24 progressive frames/sec. However, the input to the display device 110 is 60 interlaced fields/sec.

Accordingly, in one embodiment, the media player 105 provides the display device with 60 interlaced fields/sec., wherein every fifth field 605″ of five interlaced fields 605 is marked with a repeat indicator (00110, 00111) indicating that the field 605″ is a repetition of the last field of the same polarity, e.g., the third field 605′ of the five interlaced fields 605.

Additionally, in an another embodiment, the media player 105 can mark every 3^{rd} of the five frames 605′ with an indicator (10110, 10111) that the field will be repeated at the next display time of the same polarity.

FIG. 7 is a block diagram describing conversion from 30p to 60p in accordance with an embodiment of the present invention. The original rate of the video is 30 progressive frames/sec. However, the input to the display device 110 is 60 progressive frames/sec.

Accordingly, in one embodiment, the media player 105 provides the display device with 60 progressive frames/sec., wherein every other frame 705′ is marked is marked with a repeat indicator (00100) indicating that the frame 705′ is a repetition of the previous frame 705. Additionally, the media player 105 can mark frames 705 with an indicator (10100) indicating that the frame 705 will be repeated one time.

FIG. 8 is a block diagram describing conversion from 24p to 72p in accordance with an embodiment of the present invention. The original rate of the video is 24 progressive frames/sec. However, the input to the display device 110 is 72 progressive frames/sec.

Accordingly, in one embodiment, the media player 105 provides the display device with 72 progressive frames/sec. The media player 105 marks every second 805′ of three frames is marked with an indicator (00100) indicating that it is a repetition of the previous frame 805. The media player marks every third 805″ of the three frame with an indicator (01000) indicating that the frame 805″ is a repetition of the frame 805 provided before the previous frame 805′. Additionally, the media player 105 can mark frames 805 with an indicator (11000) indicating that the frame 805 is to be repeated twice.

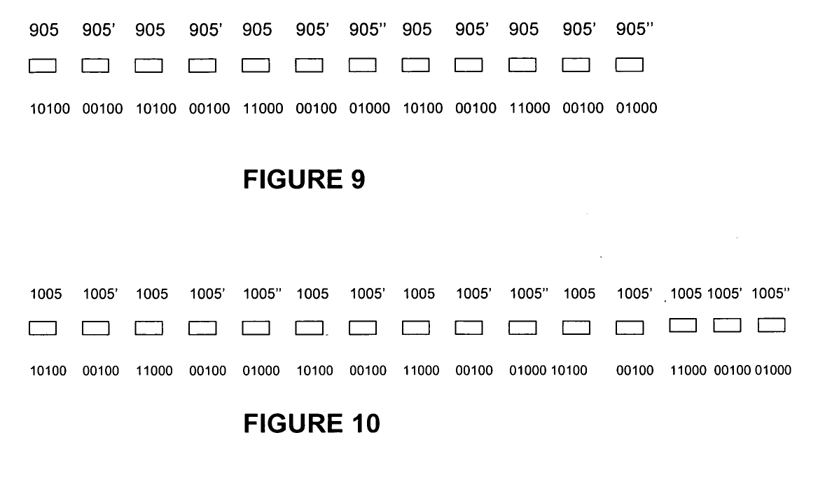

FIG. 9 is a block diagram describing conversion from 30p to 72p in accordance with an embodiment of the present invention. The original rate of the video is 30 progressive frames/sec. The original rate of the video is 30 progressive frames/sec. However, the input to the display device 110 is 72 progressive frames/sec.

Accordingly, in one embodiment, the media player 105 provides the display device with 72 progressive frames/sec. From each 12 frames, the media player 105 marks every 2^{nd}, 4^{th}, 6^{th}, 9^{th}, and 11^{th} frame 905′ with an indicator (00100) indicating that it is a repetition of the previous frame 905. From the 12 frames, the media player marks every 7^{th} and 12^{th} frame 905″ of the twelve frames with an indicator (01000) indicating that the frame 905″ is the second repetition of the frame 905 provided before the previous frame 905′. Additionally, the media player 105 can mark the 1^{st}, 3^{rd}, and 8^{th} frames 905 with an indicator (10100) indicating that the frames will be repeated once. The media player 105 can mark the 5^{th} and 10^{th} frame with an indicator (11000) indicating that the frames will be repeated twice.

FIG. 10 is a block diagram describing conversion from 30p to 75p in accordance with an embodiment of the present invention. The original rate of the video is 30 progressive frames/sec. However, the input to the display device 110 is 75 progressive frames/sec.

Accordingly, in one embodiment, the media player 105 provides the display device with 75 progressive frames/sec. From each 15 frames, the media player 105 marks every 2^{nd}, 4^{th}, 7^{th}, 12^{th}, and 14^{th} frame 1005′ with an indicator (00100) indicating that it is the first repetition of frame 905. From the 15 frames, the media player marks every 5^{th}, 10^{th}, and 15^{th} frame 1005″ of the three frame with an indicator (01000) indicating that the frame 1005″ is the second repetition of the frame 1005 provided before the previous frame 1005′. Additionally, the media player 105 can mark the 1^{st}, 6^{th}, and 11^{th} frames with an indicator (10100) indicating that the frames will be repeated once. The media player can mark the 3^{rd}, 8^{th}, and 13^{th} frames with an indicator (11000) indicating that the frames are repeated twice.

The embodiments described herein may be implemented as a board level product, as a single chip, application specific integrated circuit (ASIC), or with varying levels of the system integrated with other portions of the system as separate components. Alternatively, if the processor is available as an ASIC core or logic block, then the commercially available processor can be implemented as part of an ASIC device wherein certain aspects of the present invention are implemented as firmware.

The degree of integration may primarily be determined by the speed and cost considerations. Because of the sophisticated nature of modern processors, it is possible to utilized a commercially available processor, which may be implemented external to an ASIC implementation.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for transmitting video data, said method comprising:
transmitting a picture; and
transmitting an indicator with the picture, said indicator indicating whether the picture is repeated.

2. The method of claim 1, wherein the picture is selected from a group consisting of a picture, a field, or a frame.

3. The method of claim 1, further comprising: transmitting a header with the picture, said header comprising the indicator.

4. The method of claim 1, wherein the indicator comprises two bits, wherein the two bits indicate the number of times that the picture is repeated.

5. The method of claim 1, wherein the picture is a field, and wherein the indicator indicates whether the field is a repeat of the previous field with the same polarity.

6. The method of claim 1, wherein the picture is a field, and wherein the indicator indicates whether the field will be repeated as the next field of the same polarity.

7. The method of claim 1, wherein the indicator is transmitted during a vertical blanking interval associated with the picture.

8. A method for displaying pictures, said method comprising:
receiving pictures at a receiving rate;
receiving an indicator with at least one picture, said indicator indicating whether the picture with the indicator is repeated;
converting the pictures from the received rate to a display rate, based at least in part on the indicators; and
displaying the pictures at the display rate.

9. The method of claim 8, wherein converting the pictures to the display rate comprises:
determining a native rate based at least in part on the indicators.

10. The method of claim 8, wherein the pictures are received as progressive pictures, and wherein converting further comprises converting the progressive pictures to interlaced pictures, based on the indicators with at least one picture.

11. The method of claim 8, wherein the pictures are received as interlaced pictures, and wherein converting further comprises converting the interlaced pictures to progressive pictures, based at least in part on the indicators with at least one picture.

12. A system for displaying pictures, said system comprising:
an input for receiving pictures at a receiving rate and receiving an indicator with at least one picture, said indicator indicating whether the picture with the indicator is repeated.
a controller for converting the pictures from the received rate to a display rate, based at least in part on the indicators; and
a screen for displaying the pictures at the display rate.

13. The system of claim 12, wherein the controller determines a native rate based at least in part on the indicators with at least one picture.

14. The system of claim 12, wherein the pictures are received as progressive pictures, and wherein converting further comprises converting the progressive pictures to interlaced pictures, based at least in part on the indicators with at least one picture.

15. The system of claim 12, wherein the pictures are received as interlaced pictures, and wherein converting further comprises converting the interlaced pictures to progressive pictures, based at least in part on the indicators with at least one picture.
